(19) United States
(12) Patent Application Publication
(10) Pub. No.: US 2018/0363351 A1
(43) Pub. Date: Dec. 20, 2018

(54) METHOD AND MECHANISM FOR AUTOMATICALLY DETECTING DOOR OR WINDOW FAULTS

(71) Applicant: Beijing Eco-Smart Automation Control Technology Co., Ltd., Beijing (CN)

(72) Inventor: Xiaowei JIANG, Beijing (CN)

(21) Appl. No.: 16/116,162

(22) Filed: Aug. 29, 2018

Related U.S. Application Data
(62) Division of application No. 15/408,471, filed on Jan. 18, 2017.

(30) Foreign Application Priority Data
Aug. 23, 2016 (CN) 201610711307.1

(51) Int. Cl. E05F 7/00; E06B 7/28; E05F 11/54

(52) U.S. Cl. CPC E05F 7/00; E05Y 2800/404; E05F 11/54; E05Y 2800/426; E06B 7/28

(57) ABSTRACT

The present invention discloses a method for automatically detecting door or window faults, comprising the following steps: mounting a displacement sensor at at least one monitoring position of the door or window frame and leaf and/or door or window hardware to monitor a relative position change of the door or window frame and leaf and/or relative displacement of the hardware at said at least one monitoring position; and connecting the displacement sensor to a controller which judges whether the relative position change of the door or window frame and leaf and/or relative displacement of the hardware at said at least one monitoring position exceeds a displacement threshold, and thereby perform combined judgment for door or window faults. The present invention further discloses a mechanism for automatically detecting door or window faults. The present invention can automatically detect possible faults occurring during use of the door or window, and thereby eliminate hidden risks endangering the user and other persons' personal safety, and exhibit important social significance.

### FIELD OF THE INVENTION

The present invention relates to the field of doors and windows, and particularly to a method for automatically detecting door or window faults. The present invention further relates to a mechanism for automatically detecting door or window faults.

### BACKGROUND OF THE INVENTION

During use of doors and windows, different faults to doors and windows might be caused with elapse of time or wrong use of a user. If the faults are not handled in time, damages might be caused to the user or other groups of persons. For example, loosening of door and window hardware, fall of doors and windows and serious corner deformation, etc. cause collision between a leaf and a frame or between a leaf and ground and failure to use normally.

### SUMMARY OF THE INVENTION

In view of the above problems and other problems existing in the prior art, the present invention proposes a method and mechanism for automatically detecting door or window faults.

Correspondingly, the present invention provides a method for automatically detecting door or window faults, comprising the following steps: mounting a displacement sensor at at least one monitoring position of the door or window frame and leaf and/or door or window hardware to monitor a relative position change of the door or window frame and leaf and/or relative displacement of hardware at said at least one monitoring position; and connecting the displacement sensor to a controller which judges whether the relative position change of the door or window frame and leaf and/or relative displacement of hardware at said at least one monitoring position exceeds a displacement threshold, and thereby perform combined judgment for door or window faults.

Preferably, the displacement sensor is a reed pipe and a magnet.

Preferably, mounting a displacement sensor at at least one monitoring position of the door or window frame and leaf and/or door or window hardware comprises mounting the displacement sensor on a mounting plate of a hinge for mounting on the door or window leaf and frame and a hinge sheet, and mounting the displacement sensor at a lock seat and a lock point on the door or window on the side of a handle.

Preferably, the method further comprises the following step: sending fault explanation information via the controller, transmitting the information to a master controller in a wired or wireless transmission manner, using a human-machine interaction interface to display a fault code and indicate fault information.

Preferably, the method further comprises the following step: sending fault explanation information via the controller, transmitting the information to a master controller in a wired or wireless transmission manner, transmitting the fault information to a cloud server by the master controller via a router, and transmitting the fault information to the user's mobile terminal via the cloud server.

The present invention further provides a mechanism for automatically detecting door or window faults, comprising: a displacement sensor mounted at at least one monitoring position of the door or window frame and leaf and/or door or window hardware; and a controller connected to the displacement sensor and configured to judge whether a relative position change of the door or window frame and leaf and/or relative displacement of hardware at said at least one monitoring position exceeds a displacement threshold, and thereby perform combined judgment for door or window faults.

Preferably, the displacement sensor is a reed pipe and a magnet.

Preferably, the displacement sensor mounted at at least one monitoring position of the door or window frame and leaf and/or door or window hardware comprises a displacement senor mounted on a mounting plate of a hinge for mounting on the door or window leaf and frame and a hinge sheet, and a displacement sensor mounted at a lock seat and a lock point on the door or window on the side of a handle.

Preferably, the mechanism further comprises a master controller, the fault explanation information sent by the controller being transmitted to the master controller in a wired or wireless transmission manner, the master controller using a human-machine interaction interface to display a fault code and indicate fault information.

Preferably, the mechanism further comprises a master controller, the fault explanation information sent by the controller being transmitted to the master controller in a wired or wireless transmission manner, the fault information being transmitted to a cloud server by the master controller via a router, being transmitted to the user's mobile terminal via the cloud server.

Based on relationship between door or window hardware and associated structures, and from perspective of states and association relationship of hardware, the present invention solves the problem about how to judge whether hardware states are normal and whether relative dimensions of hardware and door or window leaf and frame are normal, thereby automatically judging whether the door or window is faulty during use without need to manually inspect and find various faults, and thereby eliminating hidden risks endangering the user and other persons' personal safety, and exhibiting important social significance.

### BRIEF DESCRIPTION OF DRAWINGS

FIG. 1 is a schematic view of a door or window with a mechanism for automatically detecting faults of the door or window according to an embodiment of the present invention;

FIG. 2-FIG. 6 illustrate other types of doors or windows on which the mechanism for automatically detecting faults of the doors or windows is arranged out of the same concept as FIG. 1, but arranged at different positions;

FIG. 7 is a schematic view of a reed pipe sensor; and

FIG. 8 is a schematic view of a method for automatically detecting faults of the door or window according to an embodiment of the present invention.

### DETAILED DESCRIPTION OF PREFERRED EMBODIMENTS

Hereunder, a method and mechanism for automatically detecting faults of a door or window according to the present invention are described in detail with reference to the figures.

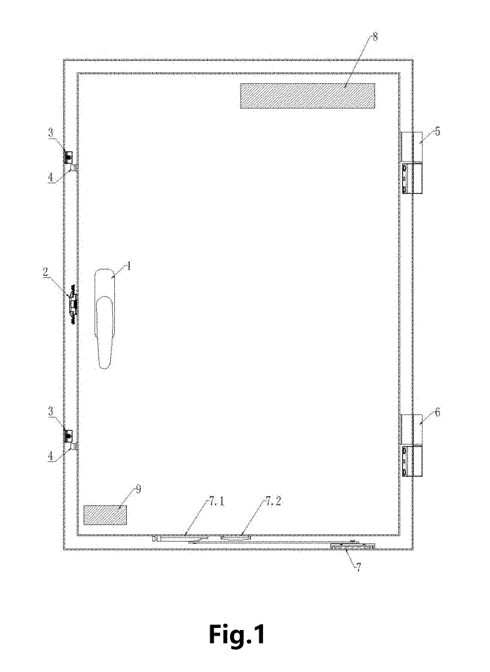

Referring to FIG. 1, it illustrates a type of door or window with a mechanism for automatically detecting faults of the door or window according to an embodiment of the present invention. The door or window shown here is a side-hung type, which is only taken as an example. The mechanism and method for automatically detecting faults of the door or window according to the present invention may further be applied to bilateral-open type, inward-open and inward-tilted, rolling shutter type, hoist-push-pull type, and inward-tilted and push-pull type doors or windows which are opened and controlled in various manners and made of various materials.

As shown in FIG. 1, the side-hung door or window mainly comprises a door or window frame, a door or window leaf and hardware. The hardware mainly comprises a handle, a door lock, a hinge, a door closer and a door holder, and functions to couple, control and fix between components of the door or window and between the door or window and a building main body. The hardware of the side-hung door or window shown in FIG. 1 at least comprises a handle 1, a transmission 2, a lock seat 3, a lock point 4, hinges 5, 6 and a wind brace 7. The hinges 5, 6 are important load-carrying parts between the door or window leaf and the door or window frame, they fix the door or window leaf to a lateral side of the door or window frame and enable the side-hung door or window to rotate upon opening. According to an embodiment of the present invention, a magnetically-sensitive reed pipe sensor or other displacement sensors may be installed on a mounting plate of the hinges 5, 6 for amounting on the door or window leaf and the door or window frame, and on a hinge sheet, for example, a reed pipe is mounted on the mounting plate of the hinges 5, 6 for amounting on the door or window leaf and the door or window frame and a magnet is mounted on the hinge sheet, or a magnet is mounted on the mounting plate of the hinges 5, 6 for amounting on the door or window leaf and the door or window frame, and a reed pipe is mounted on the hinge sheet, to judge relative displacement between the mounting plate of the hinges 5, 6 for amounting on the door or window leaf and the door or window frame and the hinge sheet, for example relative displacement of 1-2 mm If the relative position therebetween generates a displacement exceeding a threshold, e.g., a displacement exceeding 2 mm, it may be sensed by changes of relative dimensions that the hinges might loose and have a disengagement risk.

As shown in FIG. 1, a reed pipe and a magnet or other displacement sensor may be respectively mounted at locations of the lock seat 3 and lock point 4 of the door or window frame and door or window leaf on the side of the handle 1 to sense relative position changes of the door or window frame and door or window leaf. If a distance between a back plate of the hinges 5, 6 and the hinge sheet changes, this indicates that the hinges might loose and have an disengagement risk, and an amplitude of disengagement or corner drop may be learnt by judging in combination with a sensor between the lock seat 3 and lock point 4 of the door or window frame or door or window leaf on the side of the handle 1. If a displacement change occurs on the side of the hinges 5, 6, the distance between the lock seat 3 and lock point 4 of the door or window frame or door or window leaf on the side of the handle 1 certainly becomes smaller, and thereby it is judged that there is something wrong with the relative position of the door or window frame and door or window leaf, or that there is a serious problem with connection of the hinges.

According to the present invention, it is further feasible to mount the reed pipe and magnet at or nearby hardware used on the door or window or other different positions of the door or window frame and leaf, such as hardware of the handle, transmission, wind brace, door closer and door or window corners, so that relative displacement between different parts is monitored at a plurality of monitoring points of the door or window. If the relative position of a plurality of positions generates a displacement exceeding a threshold, it may be judged that the relative position of the door or window frame and leaf changes, or a screw of individual load-bearing hardware disengages or a part disengages, which causes influence on normal use of the door or window, or might causes injury to the user or other persons. The distance of the above threshold displacement may reach a relative accurate degree by adjusting a sensing distance of the sensor such as the magnet and reed pipe, and different doors or windows vary in terms of the distance to be controlled or sensed.

In addition, a manner of mounting the reed pipe and magnet on the door or window frame and leaf and hardware depends on the structure of the specific hardware or door or window frame and leaf, for example, they may be directly mounted on components, or may be mounted in components and invisible from the surface of components. The mechanism for automatically detecting the door or window faults according to the present invention preferably employs the reed pipe sensor on the grounds that it has characteristics such as simple structure, small size, high speed, long service life, easy installation in a limited space, inconspicuousness, strong resistance against load impact and very high operation reliability.

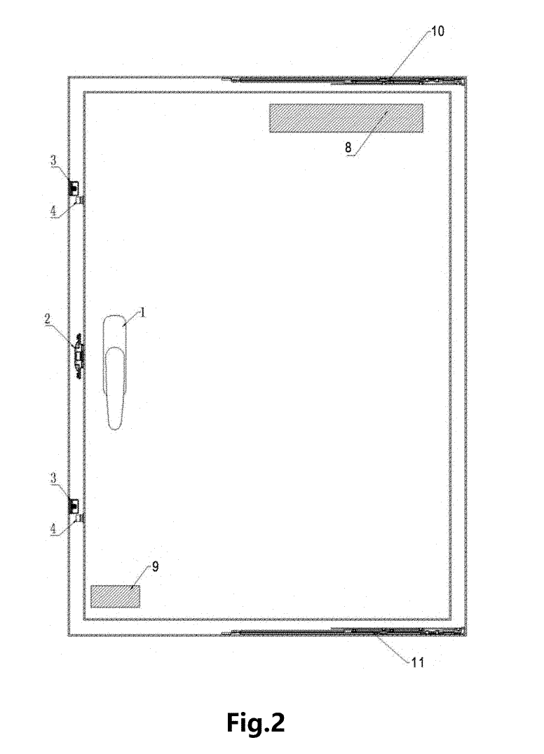

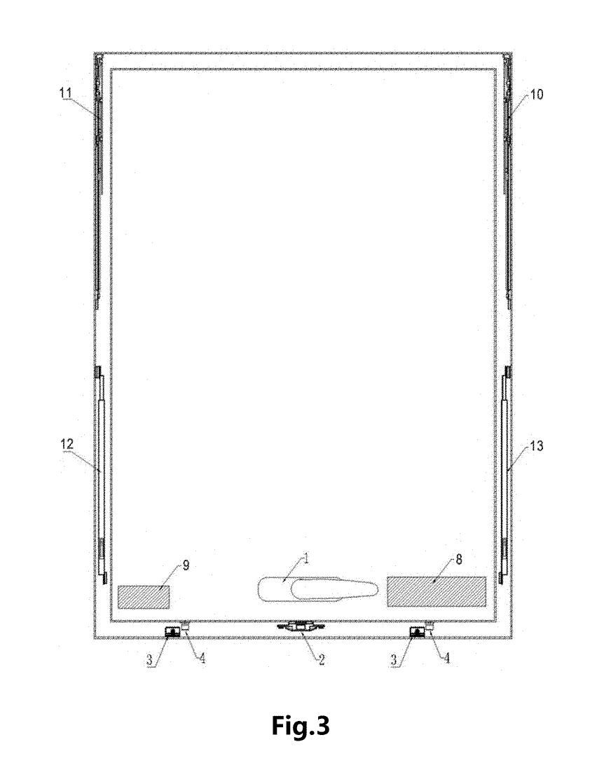

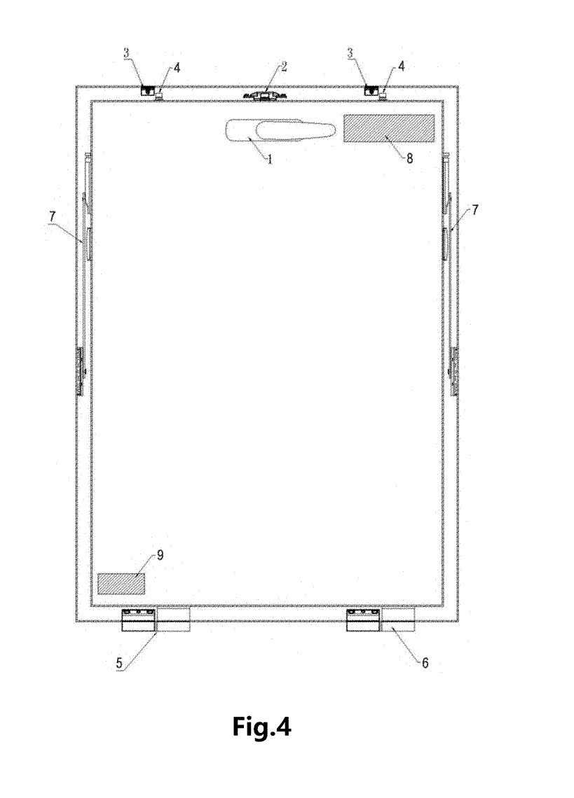

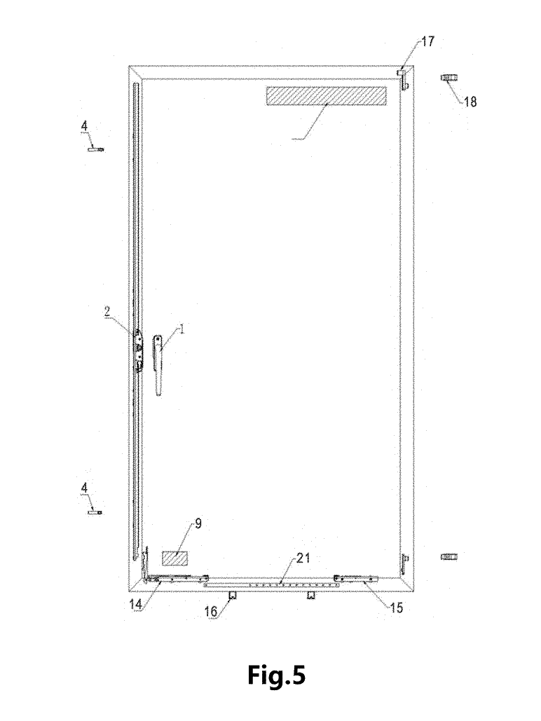

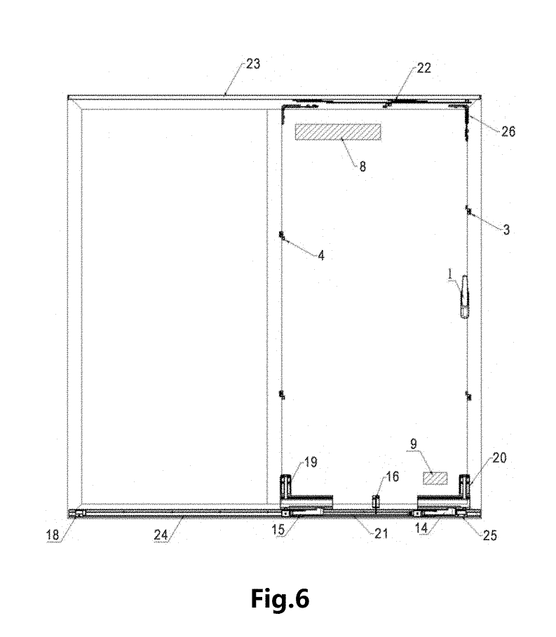

FIG. 2-FIG. 6 illustrate other types of doors or windows on which the mechanism for automatically detecting faults of the doors or windows according to the present invention is arranged. Arranging positions and structures of hardware for the doors or windows vary with different opening manners of the doors or windows. However, the concept of the mechanism and method of automatically detecting door or window faults is the same as the concept of the mechanism and method of automatically detecting door or window faults of the side-hung door or window as shown in FIG. 1, and will not be detailed here.

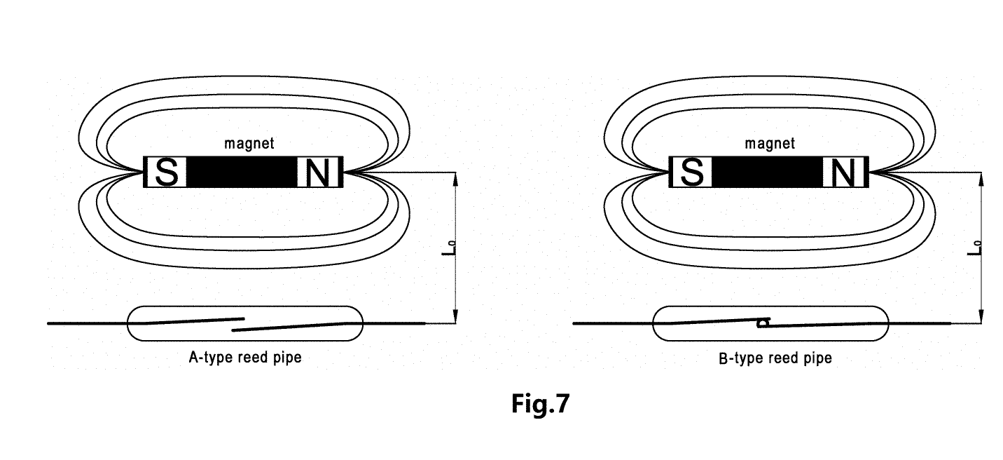

FIG. 7 illustrates a schematic view of A-type reed pipe and B-type reed pipe preferably employed by the present invention, wherein according to contact construction of the reed pipes, A-type reed pipe belongs to a reed switch which is often opened, and B-type reed pipe belongs to a reed switch which is often closed.

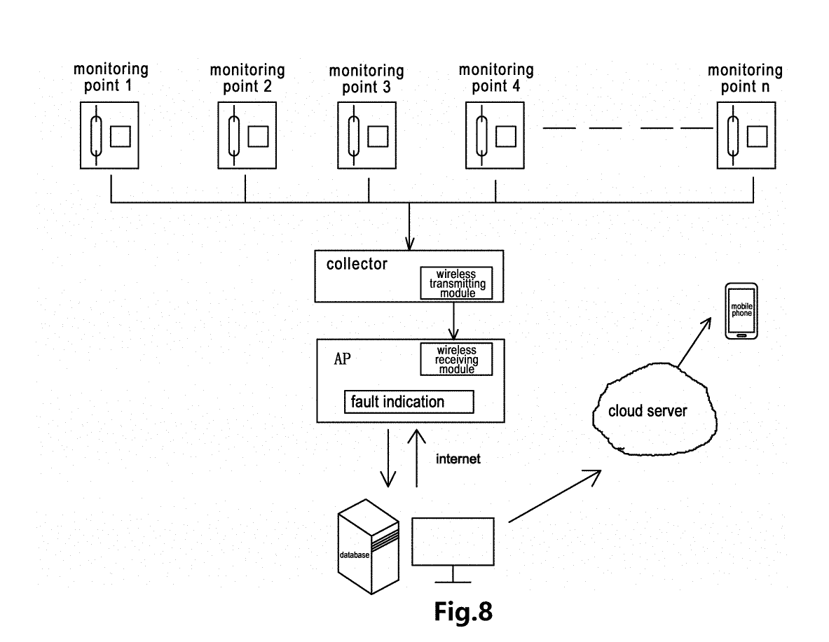

FIG. 8 is a schematic view of a method for automatically detecting door or window faults according to an embodiment of the present invention. As shown in FIG. 8, to achieve normal operation of the plurality of door or window sensors and make corresponding logic judgment, the reed pipe sensor or other displacement sensors are disposed at a plurality of monitoring points (1, 2, 3, . . . n) of the door or window hardware and/or door or window frame and leaf to monitor relative displacement between different components. All sensors are connected to a controller (e.g., a wireless collection and communication module 9) with an imbedded type MCU as a core. The controller may comprise a collector and an application processor (AP), the collector has a wireless transmitting module, the application processor has a wireless receiving module, a signal collected by the collector is transmitted by the wireless transmitting module to the application processor and received by a wireless receiving module of the application processor, the application processor performs combined judgment for the received signal and sends fault explanation information. The fault explanation information may be transmitted to a master controller (e.g., an embedded system with MCU or ARM chip architecture) in a wired or wireless transmission manner. A human-machine interaction interface may be used to display a fault code, and indicate information such as faulty door or window or causes for faults or faulty positions. In addition, the fault explanation information may be transmitted to a cloud server by the master controller via a router, then transmitted by the cloud server to the user's mobile phone or other mobile terminals to notify the user of information such as faulty door or window or causes for faults or faulty positions.

It is appreciated that the method and mechanism for automatically detecting door or window faults according to the present invention is not limited to detection of one door or window, and instead, automatic fault detection may further be made for a plurality of doors or windows simultaneously. For example, the method and mechanism may be applied to a plurality of doors and windows in a house, a plurality of doors and windows of several buildings in a residence area, a plurality of doors and windows of one office building, to thereby perform overall monitoring for doors and windows of the whole house, the whole residence area and the whole office building, automatically detect possible faults during use of doors and windows or risks endangering the user's personal safety or other persons' safety, substantially improve monitoring efficiency and safety and exhibit important social significance.

What are described above are only preferred embodiments of the present invention, and not intended to limit the present invention. Those skilled in the art appreciate that the present invention may have various modifications and variations. Any modifications, equivalent substitutes and improvements within the spirit and principles of the present invention all fall within the protection scope of the present invention.

### LISTING OF PARTS

1 Handle

2 Transmission

3 Lock seat

4 Lock point

5, 6 Hinge

7, 7.1, 7.2 Wind brace and parts

8 Motor actuator for opening a door or window

9 Wireless collection and communication module

10, 11 Hinge

12, 13 Telescopic arm

14 Driving wheel carrier

15 Driven wheel carrier

16 Bracket

17 Anti-collision block

18 Stopper

19, 20 Wheel carrier fixing sheet

21 Link rod

22 Upper sliding hinge

23 Upper slide rail

24 Lower slide rail

25 Wheel entry block

26 Corner transmission

What is claimed is:

1. A method for automatically detecting door or window faults, characterized in that the method comprises the following steps:
mounting a displacement sensor at at least one monitoring position of the door or window frame and leaf and/or door or window hardware to monitor a relative position change of the door or window frame and leaf and/or relative displacement of the hardware at said at least one monitoring position; and
connecting the displacement sensor to a controller which judges whether the relative position change of the door or window frame and leaf and/or relative displacement of the hardware at said at least one monitoring position exceeds a displacement threshold, and thereby perform combined judgment for door or window faults.

2. The method for automatically detecting door or window faults according to claim 1, characterized in that the displacement sensor is a reed pipe and a magnet.

3. The method for automatically detecting door or window faults according to claim 1 or 2, characterized in that mounting a displacement sensor at at least one monitoring position of the door or window frame and leaf and/or door or window hardware comprises mounting the displacement sensor on a mounting plate of the hinge for mounting on the door or window leaf and frame and a hinge sheet, and mounting the displacement sensor at a lock seat and a lock point on the door or window on the side of a handle.

4. The method for automatically detecting door or window faults according to claim 1 or 2, characterized in that the method further comprises the following step:
sending fault explanation information via the controller, transmitting the information to a master controller in a wired or wireless transmission manner, using a human-machine interaction interface to display a fault code and indicate fault information.

5. The method for automatically detecting door or window faults according to claim 1 or 2, characterized in that the method further comprises the following step: sending fault explanation information via the controller, transmitting the information to a master controller in a wired or wireless transmission manner, transmitting the fault information to a cloud server by the master controller via a router, and transmitting the fault information to the user's mobile terminal via the cloud server.
